(19) United States
(12) Patent Application Publication
(10) Pub. No.: US 2023/0023899 A1
(43) Pub. Date: Jan. 26, 2023

(54) POLICY LEARNING METHOD, POLICY LEARNING APPARATUS, AND PROGRAM

(71) Applicant: NEC Corporation, Minato-ku, Tokyo (JP)

(72) Inventors: Yutaka YAKUWA, Tokyo (JP); Takashi Maruyama, Tokyo (JP)

(73) Assignee: NEC Corporation, Minato-ku, Tokyo (JP)

(21) Appl. No.: 17/790,574

(22) PCT Filed: Jan. 17, 2020
(86) PCT No.: PCT/JP2020/001500

§ 371 Date: Jul. 1, 2022

(51) Int. Cl. G06N 20/20

(52) U.S. Cl. CPC G06N 20/20

(57) ABSTRACT

A policy learning apparatus of the present invention includes: a first unit configured to select a first action element based on a selection rate for each of choices of the first element whose number of choices does not depend on a state; a second unit configured to apply the selected first action element and further apply each of choices of a second action element whose number of choices depends on the state to obtain another state for each of the choices, and determine the other state based on a reward obtained by shifting to the other state and a value of the other state; and a third unit configured to further learn a model by using learning data generated based on information used when determining the other state.

### TECHNICAL FIELD

The present invention relates to a policy learning method for performing reinforcement learning, a policy learning apparatus, and a program.

### BACKGROUND ART

In general, a technique called machine learning can realize analysis, recognition, control and the like not by defining the contents of specific processing but by analyzing sample data, extracting patterns and relations in the data, and using the extracted results. As an example of such a technique, a neural network is attracting attention because it has a track record of demonstrating a capability beyond human intelligence in various tasks with a dramatic improvement in hardware performance in recent years. For example, there is a known Go program that won a game against a top professional Go player.

One of the genres of the machine learning technique is reinforcement learning. Reinforcement learning deals with a task of deciding what action an agent (referring to an “acting subject”) should take in a certain environment. When the agent performs some action, the state of the environment changes, and the environment gives some rewards for the agent's action. The agent tries an action in the environment and collects learning data with an aim of acquiring an action policy (referring to “agent's action pattern corresponding to environment state or probability distribution thereof”) that maximizes rewards which can be obtained in a long term. Thus, the characteristics of reinforcement learning are a point that learning data is not provided in advance but collected by the agent, and a point that the aim is to maximize long-term returns rather than short-term returns.

The Actor-Critic method disclosed in Non-Patent Document 1 is one of the reinforcement learning methods. The Actor-Critic method is a method of learning by using both Actor, which is a mechanism learning the action policy of the agent, and Critic, which is a mechanism learning the state value of the environment. The state value learned by Critic is used to evaluate the action policy that Actor is learning. Specifically, in a case where a prospect of the value of an action A1 executed from a state S1 is higher than a prospect of the value of the state S1 by Critic, it is determined that the value of the action A1 is high, and Actor learns so as to increase a probability of executing the action A1 from the state Sl. On the contrary, in a case where a prospect of the value of the action A1 executed from the state S1 is lower than a prospect of the value of the state S1 by Critic, it is determined that the value of the action A1 is low, and Actor learns so as to decrease a probability of executing the action A1 from the state S1. Among the reinforcement learning methods, the Actor-Critic method is highly accurate and, in particular, the method of learning with a neural network is known as a standard method in recent years.
Non-Patent Document 1: Richard S. Sutton and Andrew G. Barto: “Reinforcement Learning: An Introduction”, MIT Press, 1998.

However, the Actor-Critic method that is a technique disclosed in Non-Patent Document 1 has a problem that, on an issue that the number of types of actions which the agent can execute varies for each state of the environment, a neural network learning an action selection rate cannot be structured directly and it is hard to apply the method.

The abovementioned problem will be described in detail. First, due to the nature of a neural network, once its structure is determined, the number of values that can be output is also determined. Specifically, a neural network can output as many values as the number of units in the output layer thereof. In a case where the number of types of actions which the agent can execute is constant regardless of the state of the environment, the number of units in the output layer of the neural network is made to match the number of types of actions which the agent can execute. Consequently, it is possible to make the output of the neural network correspond to the probability distribution of the agent's action according to the state of the environment, and it is possible to realize Actor that plays a role of leaning a preferred probability distribution of the agent's action and outputting the probability distribution in the Actor-Critic method.

However, on the issue that the number of types of actions which the agent can execute varies for each state of the environment, a neural network cannot output a probability distribution with different numbers of elements (corresponding to the types of actions) for each state because the number of units in the output layer of the neural network is fixed. As a result, in general, it is difficult to apply the Actor-Critic method using a neural network to the issue that the number of types of actions which the agent can execute varies for each state of the environment.

### SUMMARY

Accordingly, one of the objects of the present invention is to provide a policy learning method which can solve the abovementioned problem; it is difficult to perform reinforcement learning on an issue that the number of types of actions which the agent can execute varies for each state of the environment.

A policy learning method as an aspect of the present invention includes, in a case where as an action element selected when a predetermined state in a predetermined environment shifts to another state, there are a first action element such that a number of choices of the action element does not depend on the state and a second action element such that a number of choices of the action element depends on the state: calculating a selection rate of each of the choices of the first action element in the state by using a model which is being learned, and selecting the first action element based on the selection rate; applying the selected first action element and further applying each of the choices of the second action element to obtain the other state for each of the choices, calculating a reward for shifting to the other state and a value of the other state, and determining the other state based on the reward and the value; and generating learning data based on information used when determining the other state, and further learning the model by using the learning data.

Further, a policy learning apparatus as an aspect of the present invention includes, in a case where as an action element selected when a predetermined state in a predetermined environment shifts to another state, there are a first action element such that a number of choices of the action element does not depend on the state and a second action element such that a number of choices of the action element depends on the state: a first unit configured to calculate a selection rate of each of the choices of the first action element in the state by using a model which is being learned, and select the first action element based on the selection rate; a second unit configured to apply the selected first action element and further apply each of the choices of the second action element to obtain the other state for each of the choices, calculate a reward for shifting to the other state and a value of the other state, and determine the other state based on the reward and the value; and a third unit configured to generate learning data based on information used when determining the other state, and further learn the model by using the learning data.

Further, a computer program as an aspect of the present invention includes instructions for causing an information processing apparatus to realize, in a case where as an action element selected when a predetermined state in a predetermined environment shifts to another state, there are a first action element such that a number of choices of the action element does not depend on the state and a second action element such that a number of choices of the action element depends on the state: a first unit configured to calculate a selection rate of each of the choices of the first action element in the state by using a model which is being learned, and select the first action element based on the selection rate; a second unit configured to apply the selected first action element and further apply each of the choices of the second action element to obtain the other state for each of the choices, calculate a reward for shifting to the other state and a value of the other state, and determine the other state based on the reward and the value; and a third unit configured to generate learning data based on information used when determining the other state, and further learn the model by using the learning data.

With the configurations as described above, the present invention makes it possible to perform reinforcement learning even on an issue that the number of types of actions which the agent can execute varies for each state of the environment.

### BRIEF DESCRIPTION OF DRAWINGS

FIG. 1 is a block diagram showing a configuration of a policy learning apparatus in a first example embodiment of the present invention;

FIG. 2 is a flow diagram showing an operation of the policy learning apparatus in the first example embodiment of the present invention;

FIG. 3 is a flow diagram showing a learning data generation operation by the policy learning apparatus in the first example embodiment of the present invention;

FIG. 4 is a flow diagram showing a learning operation by the policy learning apparatus in the first example embodiment of the present invention;

FIG. 5 is a view showing an example of a rewriting rule of a graph rewriting system in a specific example of the first example embodiment of the present invention;

FIG. 6 is a view showing an example before rewriting of a state such that there are two types of states after rewriting in the graph rewriting system in the specific example of the first example embodiment of the present invention;

FIG. 7 is a view showing an example after rewriting of a state such that there are two types of states after rewriting in the graph rewriting system in the specific example of the first example embodiment of the present invention;

FIG. 8 is a view showing an example before rewriting of a state such that there are three types of pre-rewriting states in the graph rewriting system in the specific example of the first example embodiment of the present invention;

FIG. 9 is a view showing an example after rewriting of a state such that there are three types of states after rewriting in the graph rewriting system in the specific example of the first example embodiment of the present invention;

FIG. 10 is a block diagram showing a configuration of a graph rewriting policy learning apparatus that performs learning of the graph rewriting system used in the specific example of the first example embodiment of the present invention;

FIG. 11 is a block diagram showing a hardware configuration of a policy learning apparatus in a second example embodiment of the present invention;

FIG. 12 is a block diagram showing a configuration of the policy learning apparatus in the second example embodiment of the present invention; and

FIG. 13 is a flowchart showing an operation of the policy learning apparatus in the second example embodiment of the present invention.

### EXAMPLE EMBODIMENTS

### First Example Embodiment

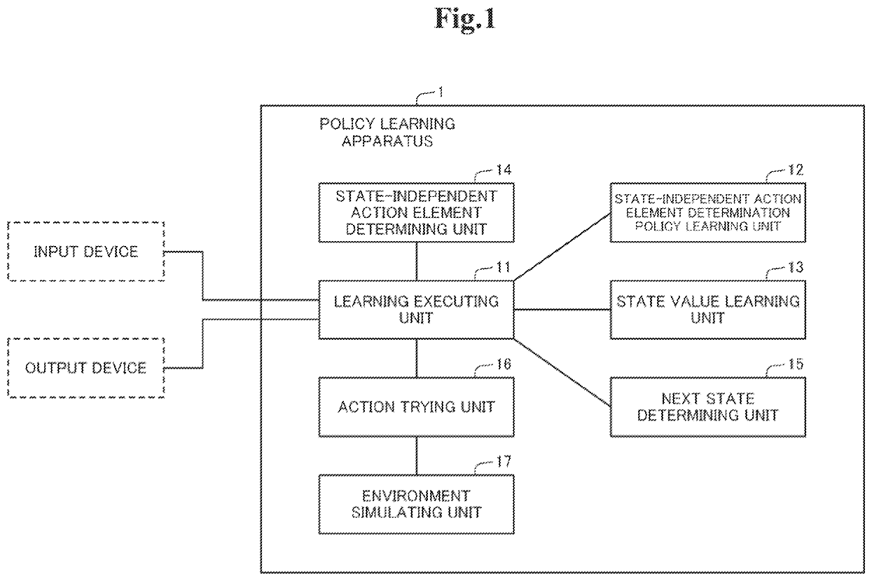

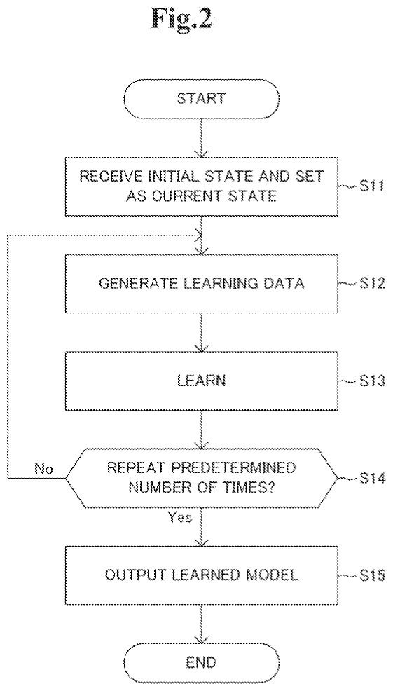

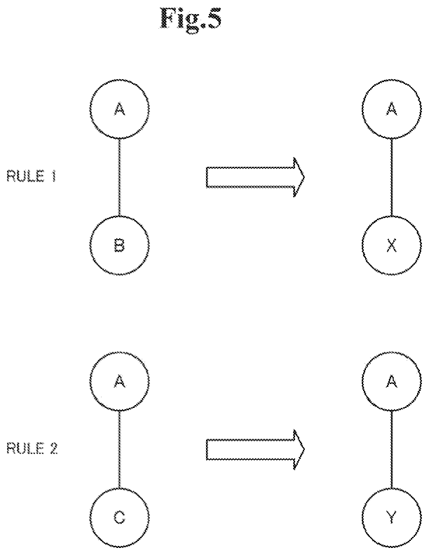

A first example embodiment of the present invention will be described with reference to FIGS. 1 to 10. FIG. 1 is a view for describing a configuration of a policy learning apparatus, and FIGS. 2 to 4 are views for describing a processing operation of the policy learning apparatus. Moreover, FIGS. 5 to 10 are views for describing a specific example of the policy learning apparatus.

### [Configuration]

A policy learning apparatus disclosed below is an apparatus which, when an agent executes an action (an action element) in a certain environment (a predetermined environment) to shift the current state (a predetermined state) to the next state (another state), performs reinforcement learning to learn so as to maximize the value. A case where, as an action element selected when a predetermined state in a predetermined environment shifts to another state, there are an action element such that the number of choices of the action element does not depend on the state (a first action element) and an action element such that the number of choices of the action element depends on the state (a second action element) will be described below.

A policy learning apparatus 1 is configured by one or a plurality of information processing apparatuses including an arithmetic logic unit and a storage unit. As shown in FIG. 1, the policy learning apparatus 1 includes a learning executing unit 11, a state-independent action element determination policy learning unit 12, a state value learning unit 13, a state-independent action element determining unit 14, a next state determining unit 15, an action trying unit 16, and an environment simulating unit 17. The respective functions of the learning executing unit 11, the state-independent action element determination policy learning unit 12, the state value learning unit 13, the state-independent action element determining unit 14, the next state determining unit 15, the action trying unit 16 and the environment simulating unit 17 can be realized by the arithmetic logic unit executing a program for realizing the respective functions stored in the storage unit. The respective units 11 to 17 have the following functions in outline.

The learning executing unit 11 (third module) supervises the state-independent action element determining unit 14, the next state determining unit 15, the action trying unit 16 and the environment simulating unit 17 to collect data necessary for learning, and supervises the state-independent action element determining policy learning unit 12 and the state value learning unit 13 to perform learning. Specifically, the learning executing unit 11 generates learning data based on information used when the next state determining unit 15 determines the next state from the current state as will be described later. Then, the learning executing unit 11 causes the state-independent action element determination policy learning unit 12 to perform learning by using the learning data, and causes the state value learning unit 13 to perform learning by using the learning data.

The state-independent action element determination policy learning unit 12 (first module, third module) learns a preferable selection rate in each state of the environment for a choice of the action element such that the number of choices does not depend on the state. That is to say, the state-independent action element determination policy learning unit 12 generates a model that calculates a selection rate of each choice of the action element such that the number of choices does not depend on the state, by using the learning data generated by the learning executing unit 11 described above. Moreover, the state-independent action element determination policy learning unit 12 inputs the current state into the generated model, and outputs the selection rate of each choice of the action element such that the number of choices does not depend on the state.

The state value learning unit 13 (second module, third module) learns the value of each state of the environment. That is to say, the state value learning unit 13 generates a model (second model) for calculating the value of the next state shifted from the current state by using the learning data generated by the learning executing unit 11 described above. Moreover, the state value learning unit 13 inputs the next state into the generated model, and outputs the value of the next state.

The state-independent action element determining unit 14 (first module) determines the selection of the action element such that the number of choices does not depend on the state in accordance with the output of the state-independent action element determination policy learning unit 12. Specifically, the state-independent action element determining unit 14 receives a selection rate of each choice of the action element such that the number of choices does not depend on the state, having been output from the state-independent action element determination policy learning unit 12, and performs the selection of an action element based on the section rate.

The action trying unit 16 (second module) tries, among actions that can be executed from the current state, an action in which the content of the action element whose number of choices does not depend on the state has been selected by the state-independent action element determining unit 14. The actions that can be executed from the current state are actions in which the action element such that the number of choices of the action element does not depend on the state is applied as a choice and moreover the action element such that the number of choices of the action element depends on the state is applied as a choice. In other words, the action trying unit 16 lists an action of each choice in which the action element selected by the state-independent action element determining unit 14 is applied and the action element such that the number of choices of the action element depends on the state is further applied as a choice, and passes the current state and the listed action contents to the environment simulating unit 17.

The environment simulating unit 17 (second module) outputs a reward for the action tried by the action trying unit 16, that is, the listed action and also changes the environment to the next state after performing the action from the current state, and passes to the next state determining unit 15.

The next state determining unit 15 (second module) determines the next state in accordance with the output by the state value learning unit 13 and the reward to return having been passed by the environment simulating unit 17 from among candidates for the next state passed by the environment simulating unit 17. Specifically, the next state determining unit 15 calculates a value obtained by adding the reward for the action from the current state to the next state to the value of the next state, and determines the next state that maximizes the added value as an actual next state.

### [Operation]

Next, the overall operation of the above policy learning apparatus 1 will be described with reference FIG. 2. First, the policy learning apparatus 1 receives at least an initial state of the environment as an input to the whole apparatus, and sets the initial state as the current state of the environment (step S11). Subsequently, the learning executing unit 11 of the policy learning apparatus 1 generates learning data (step S12), and performs learning (step S13). Then, the learning executing unit 11 repeats the above operation of steps S12 to S13 a predetermined number of times (step S14). The predetermined number of times may be given as an input to the policy learning apparatus 1, may be a value that the policy learning apparatus 1 uniquely has, or may be determined by another method. Finally, the learning executing unit 11 outputs a learned model and stores the model into the policy learning apparatus 1 (step S15).

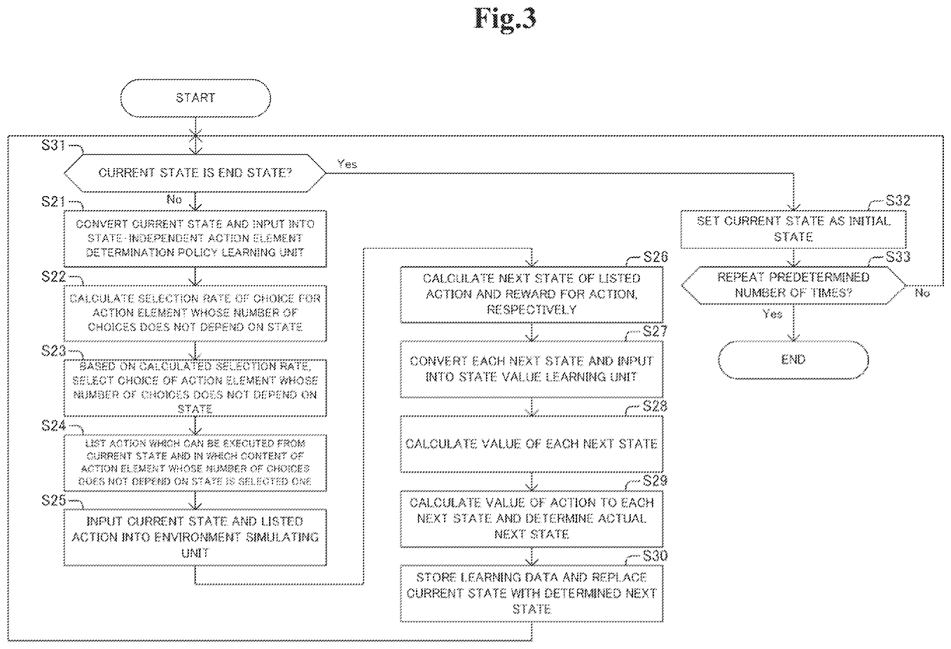

Next, step S12, that is, the operation to generate learning data will be described in more detail with reference to FIG. 3. The state-independent action element determining unit 14 generates state data obtained by converting the current state of the environment into a data format that can be input into the state-independent action element determination policy learning unit 12, and inputs the state data into the state-independent action element determination policy learning unit 12 (step S21). The data format that can be input into the state-independent action element determination policy learning unit 12 is an input format that can be accepted by a framework such as TensorFlow used as a backend of learning by the state-independent action element determination policy learning unit 12, which is generally the vector format, but is not limited thereto. Moreover, the state-independent action element policy learning unit 12 does not necessarily need to use a framework such as TensorFlow, but may use original implementation.

Subsequently, the state-independent action element determination policy learning unit 12 calculates the selection rates of choices for an action element whose number of choices does not depend on the state among action elements composing the content of an action that the agent should perform from the state represented by the input state data, and returns the calculation result to the state-independent action element determining unit 14 (step S22). Then, the state-independent action element determining unit 14 selects a choice of the action element whose number of choices does not depend on the state based on the selection rates, and passes the selection result to the action trying unit 16 (step S23). At the time, the state-independent action element determining unit 14 may select the choice in accordance with the probability, or may decisively select a choice having the highest probability.

Subsequently, the action trying unit 16 lists an action in which the content of the action element whose number of choices does not depend on the state is one selected by the state-independent action element determining unit 14, from among actions that can be executed from the current state (step S24). At the time, the actions that can be executed from the current state are actions that can be executed, respectively, with each of the choices of the action element whose number of choices depends on the state and the action element whose number of choices does not depend on the state, and the action trying unit 16 lists, from among them, an action in which the content of the action element whose number of choices does not depend on the state is one selected by the state-independent action element determining unit 14. Then, in order to try the listed action from the current state, the action trying unit 16 passes the current state and the listed action content to the environment simulating unit 17 (step S25). The environment simulating unit 17 calculates and returns a state after the action (referred to as a next state hereinafter) and a reward for the action (step S26).

Subsequently, the next state determining unit 15 generates state data obtained by converting each next state into a data format that can be input into the state value learning unit 13, and inputs the generated state data into the state value learning unit 13 (step S27). The data format that can be input into the state value learning unit 13 is an input format that can be accepted by a framework such as TensorFlow used as a backend of learning by the state value learning unit 13, which is generally the vector format, but is not limited thereto. Moreover, the state value learning unit 13 does not necessarily need to use a framework such as TensorFlow as the backend, but may use original implementation.

Then, the state value learning unit 13 calculates the value of each next state, and returns the value to the next state determining unit 15 (step S28). The next state determining unit 15 calculates, for each next state, a value obtained by adding a reward for an action executed at the time of shifting to the next state and the value of the next state, and determines a next state which maximizes the value as an actual next state (step S29).

Subsequently, the learning executing unit 11 sets the maximum value of the value obtained by adding the reward and the value calculated by the next state determining unit 15 as the value of the action executed from the current state, and stores data including a combination of the current state, the value of the action executed from the current state and the choice of the action element selected by the state-independent action element determining unit 14, as learning data. Then, the learning executing unit 11 replaces the current state with the actual next state determined by the next state determining unit 15 (step S30).

After that, the policy learning apparatus 1 repeats the operation of steps S21 to S30 described above as far as the current state is not an end state (step S31). The end state is a state where there is no action that can be executed from the state. In a case where the current state is the end state, the policy learning apparatus 1 sets the current state as the initial state input at step S11 (step S32). Then, the policy learning apparatus 1 repeats the operation of steps S21 to S32 a predetermined number of times (step S33). The predetermined number of times may be given as an input to the policy learning apparatus 1, may be a value which the policy learning apparatus 1 uniquely has, or may be determined by another method.

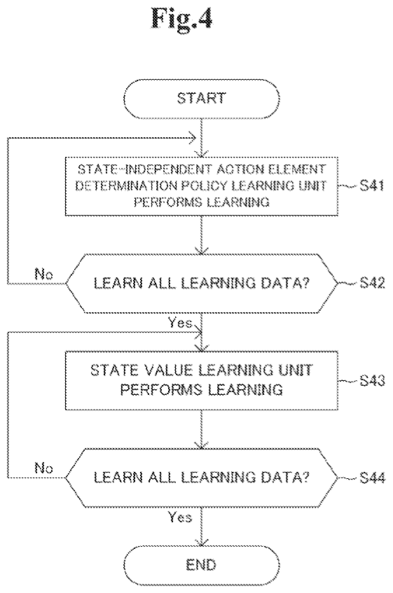

Next, step S13 described above, that is, the learning operation will be described in more detail with reference to FIG. 4. First, the state-independent action element determination policy learning unit 12 performs learning by using the learning data generated in the above manner (step S41). At the time, the target for learning by the state-independent action element determination policy learning unit 12 is a preferable selection rate of a choice for an action element whose number of choices does not depend on the state among actions that can be executed from a certain state, calculated when data in a certain state is input. Herein, a case of learning with a neural network by the policy gradient method typically used at the time of learning a policy in Actor-Critic. However, the realization method is not limited thereto.

In the policy gradient method, the neural network is updated with the loss function as “log π(s, a)×(Qπ(s, a)−Vπ(s))”. The above “π(s, a)” is a policy function and represents a probability that an action a should be selected when the state is s. The value of “π(s, a)” in this example embodiment is obtained by extracting, from a probability vector calculated when converting the state s included in the individual learning data into the input format of the state-independent action element determination policy learning unit 12 and inputting it into the state-independent action element determination policy learning unit 12, the value of an execution probability corresponding to a choice a of the action element included in the learning data. The above “Qπ(s, a)” is an action value function and represents a value when the action a is performed from the state s in the case of acting in accordance with the policy function π. As the value of “Qπ(s, a)” in this example embodiment, the value of an action executed from a state included in the individual learning data is used. The above “Vπ(s)” is a state value function and represents the value of the state s in the case of acting in accordance with the policy function π. As the value of “Vπ(s)” in this example embodiment, the value of a state value calculated when converting the state s included in the individual learning data into the input format of the state value learning unit 13 and inputting it into the state value learning unit 13 is used.

Then, by using an output from the state-independent action element determination policy learning unit 12 for an input, which is the state s included in the individual learning data converted into the input format of the state-independent action element determination policy learning unit 12, and the individual learning data, the state-independent action element determination policy learning unit 12 performs learning, that is, updates each weight value of the neural network held by the state-independent action element determination policy learning unit 12 based on the loss function described above. Although the learning is typically performed using a framework such as TensorFlow and can also be realized by this method in this example embodiment, the learning is not limited to this method.

The abovementioned learning by the state-independent action element determination policy learning unit 12 (step S41) may be individually performed for each learning data, may be performed for each appropriate size, or may be collectively performed on all the learning data. Then, the state-independent action element determination policy learning unit 12 repeats the operation of step S41 until learning all the learning data (step S42).

Further, the state value learning unit 13 performs learning by using the abovementioned learning data (step S43). At the time, the target for learning by the state value learning unit 13 is the value of a certain state calculated when data of the certain state is input. Here, in the learning of the state value, the neural network is updated with the loss function as “(Qπ(s, a)−Vπ(s))\hat{ }2”. The definitions of “Qπ(s, a)” and “Vπ(s)” and the calculation method of the values are as described before. The symbol “\hat{ }” represents a power.

Then, by using an output from the state value learning unit 13 for an input, which is the state s included in the individual learning data converted into the input format of the state value learning unit 13, and the individual learning data, the state value learning unit 13 performs learning, that is, updates each weight value of the neural network held by the state value learning unit 13 based on the loss function described above. Although the learning is typically performed using a framework such as TensorFlow and can also be realized by this method in this example embodiment, the learning is not limited to this method. The abovementioned learning by the state value learning unit 13 (step S43) may be individually performed for each learning data, may be performed for each appropriate size, or may be collectively performed on all the learning data. Then, the state value learning unit 13 repeats the operation of step S43 until learning all the learning data (step S44).

### Specific Example

Next, a specific example of the first example embodiment will be described. In particular, specific examples of an action element such that the number of types of choices of the action element depends on the state of the environment and an action element such that the number of types of choices of the action element does not depend on the state of the environment are included as action elements composing the content of an action that can be executed by the agent, and a task of having such action elements as the action elements of the agent will be illustrated.

As the abovementioned task, a graph rewriting system will be described as an example. The graph rewriting system is a state transition system in which a “graph” is regarded as a “state” and “graph rewriting” is regarded as “transition”. Therefore, a “set of states” that defines the graph rewriting system is defined as a “set of graphs”, and a “set of transitions” that defines the graph rewriting system is defined as a “set of graph rewriting rules”. In the case of applying reinforcement learning to the graph rewriting system, a “state” of the environment corresponds to a “graph”, and “action” that can be executed by the agent corresponds to “graph rewriting” that can be applied to the graph that is the current state.

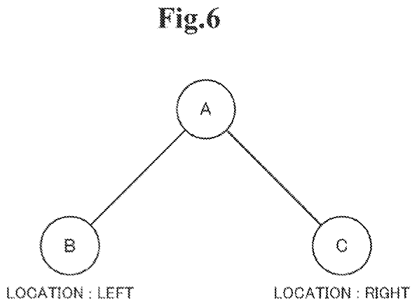

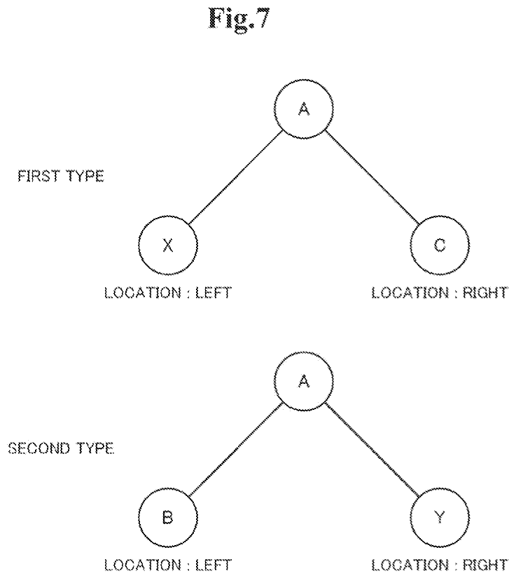

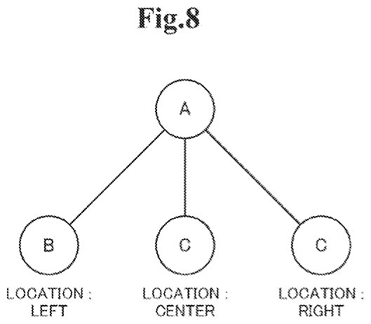

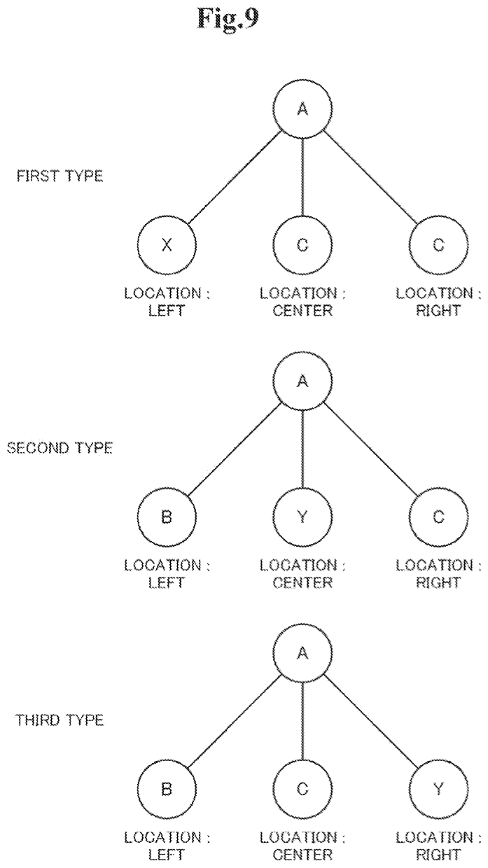

Here, graph rewriting, which is an action that can be executed by the agent, depends on the state. This is because the individual graph rewriting rules can be applied to a plurality of locations in the graph. For example, assuming the environment (graph rewriting system) has rewriting rules as shown in FIG. 5, in a case where the graph that is the current state is as shown in FIG. 6, a state after one transition (graph rewriting) is one of the two types shown in FIG. 7. On the other hand, in a case where the graph that is the current state is as shown in FIG. 8, a state after one transition (graph rewriting) is one of the three types shown in FIG. 9. Thus, in the case of applying reinforcement learning to the graph rewriting system, the number of types of actions that can be executed by the agent varies depending on the state. Then, it is impossible to apply the Actor-Critic method using the neural network as it is for the reason described above.

Therefore, an action executed by the agent is divided into an action element whose number of types of choices does not depend on the state and an action element whose number of types of choices depends on the state. In the example of the graph rewriting system, the action element whose number of types of choices does not depend on the state (first action element) is the type of “graph rewriting rule”, and the action element whose number of types of choices depends on the state (second action element) is “location in graph (rule application location)” to which the graph rewriting rule is applied. The choices of types of “graph rewriting rule” are, for example, “rule 1” and “rule 2” in the case shown in FIG. 5, and the number of types thereof does not depend on the state. Moreover, the choices of “location in graph” to which the graph rewriting rule is applied are, for example, “location: left” and “location: right” in the case shown in FIGS. 6 to 7, and are, for example, “location: left”, “location: center” and “location: right” in the case shown in FIGS. 8 to 9.

Then, in the case of applying the abovementioned policy learning apparatus 1 to reinforcement learning of the graph rewriting system, when the agent executes an action from a certain state, first, the state-independent action element determination policy learning unit 12 calculates a probability distribution (selection rate) what type of graph rewriting rule should be selected (correspond to step S22 of FIG. 3). Then, the state-independent action element determining unit 14 selects a specific type of graph rewriting rule in accordance with the probability distribution of the graph rewriting rule output by the state-independent action element determination policy learning unit 12 (correspond to step S23 of FIG. 3).

After that, the next state determining unit 15 determines which of the executable rewritten graphs rewritten by the selected specific type of graph rewriting rule is to be set as the graph of the next state (correspond to step S29 of FIG. 3). At the time, the action trying unit 16 actually applies the selected graph rewriting rule to the respective locations in the graph to which the selected graph rewriting rule can be applied, and lists graphs after rewriting the graph (correspond to step S24 of FIG. 3). Subsequently, the environment simulating unit 17 calculates the value of a reward for the graph rewriting, and the state value learning unit 13 calculates the value of the graph after rewriting (correspond to steps S26 and S28 of FIG. 3). Then, the next state determining unit 15 selects a graph that maximizes the total of the reward and the value (correspond to step S29 of FIG. 3).

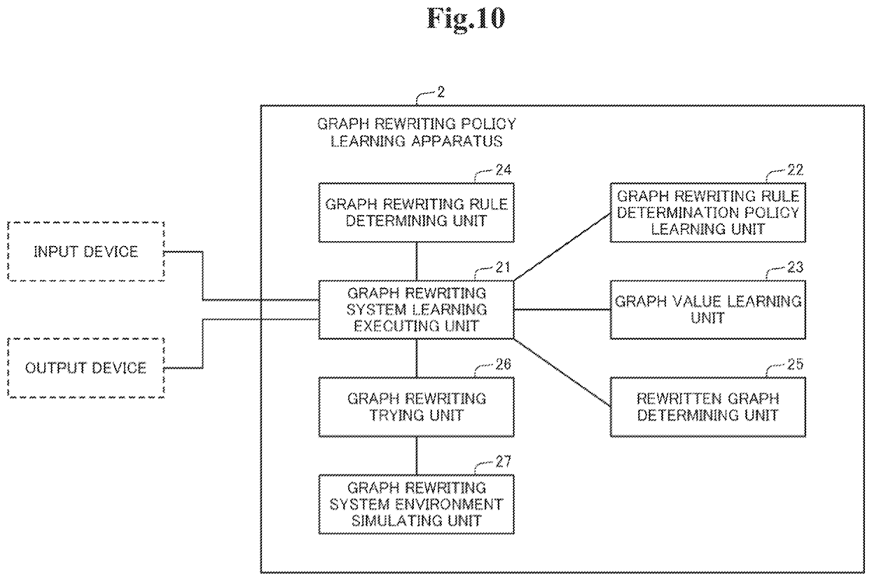

In the above specific example, the case of performing reinforcement learning by using the policy learning apparatus 1 shown in FIG. 1 described above has been described, but a policy learning apparatus may have a configuration of a graph rewriting policy learning apparatus 2 shown in FIG. 10. The graph rewriting policy learning apparatus 2 includes a graph rewriting system learning executing unit 21, a graph rewriting rule determination policy learning unit 22, a graph value learning unit 23, a graph rewriting rule determining unit 24, a rewritten graph determining unit 25, a graph rewriting trying unit 26, and a graph rewriting system environment simulating unit 27. The respective units 21 to 27 have equivalent functions to those of the learning executing unit 11, the state-independent action element determination policy learning unit 12, the state value learning unit 13, the state-independent action element determining unit 14, the next state determining unit 15, the action trying unit 16, and the environment simulating unit 17 included by the policy learning apparatus 1 described above.

As described above, in the first example embodiment and the specific example thereof described above, action elements that are components determining the content of an action are divided into an action element whose number of choices depends on the state (second action element) and an action element whose number of choices does not depend on the state (first action element), and first, a choice is determined in accordance with the conventional Actor-Critic method only for the action element whose number of choices does not depend on the state (first action element). Then, for the action element whose number of choices depends on the state (second action element), a choice is determined by another function. By doing so, even on an issue that the number of types of actions that can be executed by the agent varies for each state of the environment, it is possible to learn with a neural network in which the number of units in the output layer is fixed. This can solve the abovementioned problem that on an issue that the number of types of actions that can be executed by the agent varies for each state of the environment, it is impossible to directly construct a neural network that learns the selection rate of an action. As a result, the present invention makes it possible to apply the Actor-Critic method using a neural network to an issue to which it is hard to apply the Actor-Critic method.

The present invention, which has been illustrated using the first example embodiment and the specific example thereof described above, can be preferably applied to reinforcement learning aimed at acquiring an efficient procedure for intellectual work (for example, IT system design process) results in an issue that the number of types of actions that can be executed by the agent varies for each state of the environment, represented by the graph rewriting system, and the like.

### Second Example Embodiment

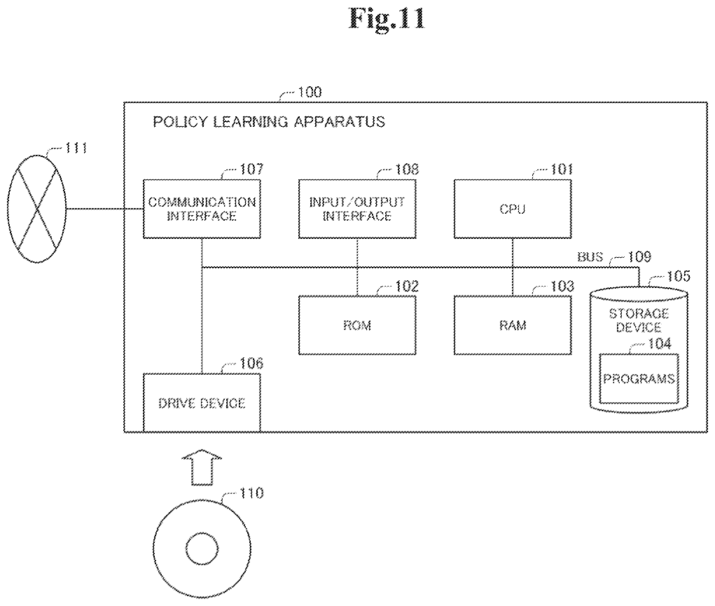

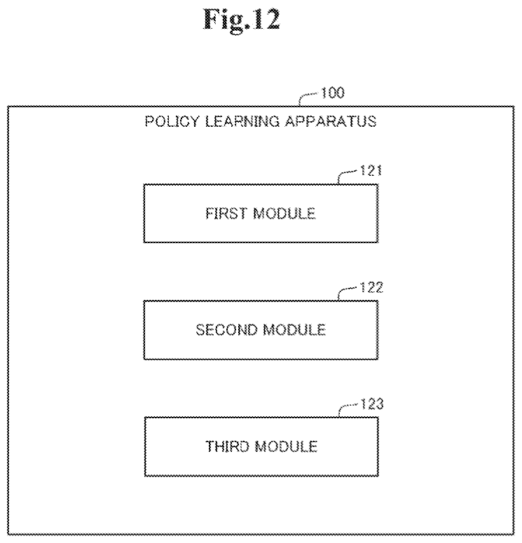

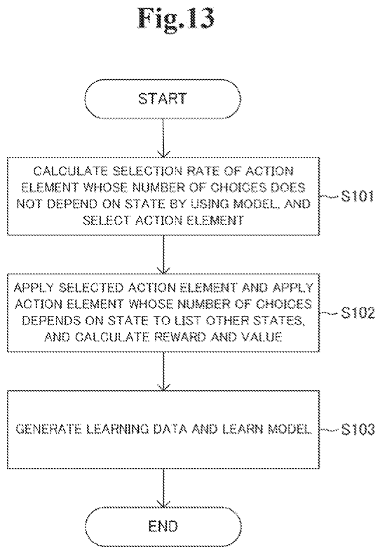

Next, a second example embodiment of the present invention will be described with reference to FIGS. 11 to 13. FIGS. 11 to 12 are block diagrams showing a configuration of a policy learning apparatus in the second example embodiment, and FIG. 13 is a flowchart showing an operation of the policy learning apparatus. In this example embodiment, the overview of configurations of the policy learning apparatus and the policy learning method executed by the policy learning apparatus described in the above example embodiment will be described.

First, with reference to FIG. 11, a hardware configuration of a policy learning apparatus 100 in this example embodiment will be described. The policy learning apparatus 100 is configured by one or a plurality of general information processing apparatuses and, as an example, has the following hardware configuration including;

a CPU (Central Processing Unit) 101 (arithmetic logic unit),

a ROM (Read Only Memory) 102 (storage unit),

a RAM (Random Access Memory) 103 (storage unit),

programs 104 loaded to the RAM 103,

a storage device 105 storing the programs 104,

a drive device 106 reading from and writing into a storage medium 110 outside the information processing apparatus,

a communication interface 107 connected to a communication network 111 outside the information processing apparatus,

an input/output interface 108 performing input and output of data, and

a bus 109 connecting the respective components.

The policy learning apparatus 100 can structure and include a first module 121, a second module 122, and a third module 123 shown in FIG. 12 by acquisition and execution of the programs 104 by the CPU 101. For example, the programs 104 are stored in the storage device 105 or the ROM 102 in advance, and are loaded to the RAM 103 and executed by the CPU 101 as necessary. The programs 104 may be supplied to the CPU 101 via the communication network 111, or may be stored in the storage medium 110 in advance and retrieved by the drive device 106 and supplied to the CPU 101. The abovementioned first module 121, second module 122 and third module 123 may be structured by a dedicated electronic circuit that can realize these modules.

FIG. 11 shows an example of the hardware configuration of the information processing apparatus serving as the policy learning apparatus 100, and the hardware configuration of the information processing apparatus is not limited to the above case. For example, the information processing apparatus may be configured by part of the above configuration, such as excluding the drive device 106.

The policy learning apparatus 100 executes a policy learning method shown in the flowchart of FIG. 13 by the functions of the first module 121, the second module 122 and the third module 123 structured by the program as described above.

As shown in FIG. 13, the policy learning apparatus 100 is configured to, in a case where as an action element selected when a predetermined state in a predetermined environment shifts to another state, there are a first action element such that a number of choices of the action element does not depend on the state and a second action element such that a number of choices of the action element depends on the state: calculate a selection rate of each of the choices of the first action element in the state by using a model which is being learned, and selects the first action element based on the selection rate (step S101); apply the selected first action element and further apply each of the choices of the second action element to obtain the other state for each of the choices, calculate a reward for shifting to the other state and a value of the other state, and determine the other state based on the reward and the value (step S102); and generate learning data based on information used when determining the other state, and further learn the model by using the learning data (step S103).

According to the second example embodiment, action elements that are components determining the content of an action are divided into a first action element whose number of choices does not depend on the state and a second action element whose number of choices depends on the state, and a choice of the first action element is determined in accordance with the Actor-Critic method. Then, a choice of the second action element is determined by another function. By doing so, even on an issue that the number of types of actions that can be executed by the agent varies for each state of the environment, it is possible to learn with a neural network in which the number of units in the output layer is fixed. This can solve the abovementioned problem that on an issue that the number of types of actions that can be executed by the agent varies for each state of the environment, it is impossible to directly construct a neural network that learns the selection rate of an action.

Although the present invention has been described above with reference to the example embodiments and the like, the present invention is not limited to the above example embodiments. The configurations and details of the present invention can be changed in various manners that can be understood by one skilled in the art within the scope of the present invention. Moreover, at least one or more functions among the functions of the learning executing unit 11, the state-independent action element determination policy learning unit 12, the state value learning unit 13, the state-independent action element determining unit 14, the next state determining unit 15, the action trying unit 16, the environment simulating unit 17, the first module 121, the second module 122 and the third module 123 included by the policy learning apparatuses described above may be executed by an information processing apparatus set up in any place on the network and connected, that is, may be executed by so-called cloud computing.

The abovementioned program can be stored by using various types of non-transitory computer-readable mediums and supplied to a computer. The non-transitory computer-readable mediums include various types of tangible storage mediums. Examples of the non-transitory computer-readable mediums include a magnetic recording medium (for example, a flexible disk, a magnetic tape, a hard disk drive), a magnetooptical recording medium (for example, a magnetooptical disk), a CD-ROM (Read Only Memory), a CD-R, a CD-R/W, and a semiconductor memory (for example, a mask ROM, a PROM (Programmable ROM), an EPROM (Erasable PROM), a flash ROM, a RAM (Random Access Memory). Moreover, the program may be supplied to a computer by various types of transitory computer-readable mediums. Examples of the transitory computer-readable mediums include an electric signal, an optical signal, and an electromagnetic wave. The transitory computer-readable mediums can supply the program to a computer via a wired communication path such as an electric wire and an optical fiber or via a wireless communication path.

### <Supplementary Notes>

The whole or part of the example embodiments disclosed above can be described as the following supplementary notes. Below, the overview of configurations of a policy learning method, a policy learning apparatus and a program according to the present invention will be described. However, the present invention is not limited to the following configurations.

### (Supplementary Note 1)

A policy learning method comprising, in a case where as an action element selected when a predetermined state in a predetermined environment shifts to another state, there are a first action element such that a number of choices of the action element does not depend on the state and a second action element such that a number of choices of the action element depends on the state:

calculating a selection rate of each of the choices of the first action element in the state by using a model which is being learned, and selecting the first action element based on the selection rate;

applying the selected first action element and further applying each of the choices of the second action element to obtain the other state for each of the choices, calculating a reward for shifting to the other state and a value of the other state, and determining the other state based on the reward and the value; and

generating learning data based on information used when determining the other state, and further learning the model by using the learning data.

### (Supplementary Note 2)

The policy learning method according to Supplementary Note 1, comprising:

calculating the value of the other state by using a second model which is being learned; and

further learning the second model by using the learning data.

### (Supplementary Note 3)

The policy learning method according to Supplementary Note 1 or 2, comprising

determining the other state maximizing a sum of the reward and the value.

### (Supplementary Note 4)

The policy learning method according to any of Supplementary Notes 1 to 3, comprising

generating the learning data in which at least the state, the selected first action element, and a maximum value of a sum of the reward and the value calculated when determining the other state are associates.

### (Supplementary Note 5)

The policy learning method according to any of Supplementary Notes 1 to 4, wherein

in a case where the environment is a graph rewriting system in which a graph serving as the state is rewritten and thereby shifted to another graph serving as the other state, the first action element is a graph rewriting rule representing a rule for rewriting the graph, and the second action element is a rule application location representing a location to apply the graph rewriting rule in the graph.

### (Supplementary Note 6)

The policy learning method according to Supplementary Note 5, comprising:

calculating a selection rate of each of choices of the graph rewriting rule in the graph by using the model, and selecting the graph rewriting rule based on the selection rate; and

applying the selected graph rewriting rule to each of the rule application locations in the graph to obtain the other state, calculating the reward and the value for the other state, and determining the other state based on the reward and the value.

### (Supplementary Note 7)

A policy learning apparatus comprising, in a case where as an action element selected when a predetermined state in a predetermined environment shifts to another state, there are a first action element such that a number of choices of the action element does not depend on the state and a second action element such that a number of choices of the action element depends on the state:

a first unit configured to calculate a selection rate of each of the choices of the first action element in the state by using a model which is being learned, and select the first action element based on the selection rate;

a second unit configured to apply the selected first action element and further apply each of the choices of the second action element to obtain the other state for each of the choices, calculate a reward for shifting to the other state and a value of the other state, and determine the other state based on the reward and the value; and

a third unit configured to generate learning data based on information used when determining the other state, and further learn the model by using the learning data.

### (Supplementary Note 8)

The policy learning apparatus according to Supplementary Note 7, wherein:

the second unit is configured to calculate the value of the other state by using a second model which is being learned; and

the third unit is configured to further learn the second model by using the learning data.

### (Supplementary Note 9)

The policy learning apparatus according to Supplementary Note 7 or 8, wherein

the second unit is configured to determine the other state maximizing a sum of the reward and the value.

### (Supplementary Note 10)

The policy learning apparatus according to any of Supplementary Notes 7 to 9, wherein

the third unit is configured to generate the learning data in which at least the state, the selected first action element, and a maximum value of a sum of the reward and the value calculated when determining the other state are associates.

### (Supplementary Note 11)

The policy learning apparatus according to any of Supplementary Notes 7 to 10, wherein

in a case where the environment is a graph rewriting system in which a graph serving as the state is rewritten and thereby shifted to another graph serving as the other state, the first action element is a graph rewriting rule representing a rule for rewriting the graph, and the second action element is a rule application location representing a location to apply the graph rewriting rule in the graph.

### (Supplementary Note 12)

The policy learning apparatus according to Supplementary Note 11, wherein:

the first unit is configured to calculate a selection rate of each of choices of the graph rewriting rule in the graph by using the model, and select the graph rewriting rule based on the selection rate; and

the second unit is configured to apply the selected graph rewriting rule to each of the rule application locations in the graph to obtain the other state, calculate the reward and the value for the other state, and determine the other state based on the reward and the value.

### (Supplementary Note 13)

A non-transitory computer-readable storage medium having a program stored therein, the program comprising instructions for causing an information processing apparatus to realize, in a case where as an action element selected when a predetermined state in a predetermined environment shifts to another state, there are a first action element such that a number of choices of the action element does not depend on the state and a second action element such that a number of choices of the action element depends on the state:

a first unit configured to calculate a selection rate of each of the choices of the first action element in the state by using a model which is being learned, and select the first action element based on the selection rate;

a second unit configured to apply the selected first action element and further apply each of the choices of the second action element to obtain the other state for each of the choices, calculate a reward for shifting to the other state and a value of the other state, and determine the other state based on the reward and the value; and

a third unit configured to generate learning data based on information used when determining the other state, and further learn the model by using the learning data.

### DESCRIPTION OF NUMERALS

1 policy learning apparatus
11 learning executing unit
12 state-independent action element determination policy learning unit
13 state value learning unit
14 state-independent action element determining unit
15 next state determining unit
16 action trying unit
17 environment simulating unit
2 graph rewriting policy learning apparatus
21 graph rewriting system learning executing unit
22 graph rewriting rule determination policy learning unit
23 graph value learning unit
24 graph rewriting rule determining unit
25 rewritten graph determining unit
26 graph rewriting trying unit
27 graph rewriting system environment simulating unit
100 policy learning apparatus
101 CPU
102 ROM
103 RAM
104 programs
105 storage device
106 drive device
107 communication interface
108 input/output interface
109 bus
110 storage medium
111 communication network
121 first module
122 second module
123 third module

What is claimed is:

1. A policy learning method comprising, in a case where as an action element selected when a predetermined state in a predetermined environment shifts to another state, there are a first action element such that a number of choices of the action element does not depend on the state and a second action element such that a number of choices of the action element depends on the state:
calculating a selection rate of each of the choices of the first action element in the state by using a model which is being learned, and selecting the first action element based on the selection rate;
applying the selected first action element and further applying each of the choices of the second action element to obtain the other state for each of the choices, calculating a reward for shifting to the other state and a value of the other state, and determining the other state based on the reward and the value; and
generating learning data based on information used when determining the other state, and further learning the model by using the learning data.

2. The policy learning method according to claim 1, comprising:
calculating the value of the other state by using a second model which is being learned; and
further learning the second model by using the learning data.

3. The policy learning method according to claim 1, comprising
determining the other state maximizing a sum of the reward and the value.

4. The policy learning method according to claim 1, comprising
generating the learning data in which at least the state, the selected first action element, and a maximum value of a sum of the reward and the value calculated when determining the other state are associates.

5. The policy learning method according to claim 1, wherein
in a case where the environment is a graph rewriting system in which a graph serving as the state is rewritten and thereby shifted to another graph serving as the other state, the first action element is a graph rewriting rule representing a rule for rewriting the graph, and the second action element is a rule application location representing a location to apply the graph rewriting rule in the graph.

6. The policy learning method according to claim 5, comprising:
calculating a selection rate of each of choices of the graph rewriting rule in the graph by using the model, and selecting the graph rewriting rule based on the selection rate; and
applying the selected graph rewriting rule to each of the rule application locations in the graph to obtain the other state, calculating the reward and the value for the other state, and determining the other state based on the reward and the value.

7. A policy learning apparatus, comprising:
at least one memory configured to store instructions; and
at least one processor configured to execute the instructions to, in a case where as an action element selected when a predetermined state in a predetermined environment shifts to another state, there are a first action element such that a number of choices of the action element does not depend on the state and a second action element such that a number of choices of the action element depends on the state:
calculate a selection rate of each of the choices of the first action element in the state by using a model which is being learned, and select the first action element based on the selection rate;
apply the selected first action element and further apply each of the choices of the second action element to obtain the other state for each of the choices, calculate a reward for shifting to the other state and a value of the other state, and determine the other state based on the reward and the value; and
generate learning data based on information used when determining the other state, and further learn the model by using the learning data.

8. The policy learning apparatus according to claim 7, wherein the at least one processor is configured to execute the instructions to:
calculate the value of the other state by using a second model which is being learned; and
further learn the second model by using the learning data.

9. The policy learning apparatus according to claim 7, wherein the at least one processor is configured to execute the instructions to:
determine the other state maximizing a sum of the reward and the value.

10. The policy learning apparatus according to claim 7, wherein the at least one processor is configured to execute the instructions to:
generate the learning data in which at least the state, the selected first action element, and a maximum value of a sum of the reward and the value calculated when determining the other state are associates.

11. The policy learning apparatus according to claim 7, wherein
in a case where the environment is a graph rewriting system in which a graph serving as the state is rewritten and thereby shifted to another graph serving as the other state, the first action element is a graph rewriting rule representing a rule for rewriting the graph, and the second action element is a rule application location representing a location to apply the graph rewriting rule in the graph.

12. The policy learning apparatus according to claim 11, wherein the at least one processor is configured to execute the instructions to:
calculate a selection rate of each of choices of the graph rewriting rule in the graph by using the model, and select the graph rewriting rule based on the selection rate; and
apply the selected graph rewriting rule to each of the rule application locations in the graph to obtain the other state, calculate the reward and the value for the other state, and determine the other state based on the reward and the value.

13. A non-transitory computer-readable storage medium having a program stored therein, the program comprising instructions for causing an information processing apparatus to execute processes to, in a case where as an action element selected when a predetermined state in a predetermined environment shifts to another state, there are a first action element such that a number of choices of the action element does not depend on the state and a second action element such that a number of choices of the action element depends on the state:
calculate a selection rate of each of the choices of the first action element in the state by using a model which is being learned, and select the first action element based on the selection rate;
apply the selected first action element and further apply each of the choices of the second action element to obtain the other state for each of the choices, calculate a reward for shifting to the other state and a value of the other state, and determine the other state based on the reward and the value; and
generate learning data based on information used when determining the other state, and further learn the model by using the learning data.
